(19) United States
(12) Patent Application Publication
(10) Pub. No.: US 2008/0120087 A1
(43) Pub. Date: May 22, 2008

(54) Translation Information Segment

(76) Inventor: Philip Scanlan, Las Vegas, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 10/563,162

(22) PCT Filed: Feb. 21, 2002
(86) PCT No.: PCT/AU02/00184

§ 371 Date: Dec. 24, 2005

(30) Foreign Application Priority Data
Feb. 22, 2001 (AU) PR 3295

(51) Int. Cl. G06F 17/28; G10L 21/00

(52) U.S. Cl. 704/2; 704/201; 704/5; 707/E17.108

(57) ABSTRACT

A method and apparatus for using translation information segment to provide seamless translation of a communication in a network environment. The communication contains a readable translation information segment that includes global translation parameters to obtain translation of the communication from a first language to a target language. The translation information is analyzed to obtain the translation parameters to be used in translating the communication. The translation information preferably includes at least one of: a pointer to a translation of the communication; or a pointer to a translation engine for translating the communication; or a pointer to a human translator skilled in translating the communication.

This invention relates generally to the field of translation, and more particularly to a translation information segment that facilitates seamless translation of communications.

The invention also relates to a method and apparatus for using the translation information segment to provide seamless translation of a communication in a network environment.

### BACKGROUND TO THE INVENTION

Machine translation of communication from one language to another is breaking down the communication barrier between individuals and businesses. Over the past twenty years there have been steady improvements in the quality of machine translation. Various techniques have been developed that translate by phrase rather than word by word. Other techniques use dictionaries or translation memories to translate whole sentences. As a result the grammar of translated communications has improved and hence the readability. Some of the best translation programs are approaching the quality of human translation for common languages and for specific purposes.

Although the technical ability of machine translation software has improved dramatically, the usability has improved very little. In order to translate a document, email or other communication, it is generally necessary to access a translation site and run a translation program. Parameters for the program, such as source and destination language, preferred dictionary, special words, etc, must be input by the user.

In our co-pending U.S. patent application Ser. No. 09/676,690 we describe a one-click translation system that avoids much of the user input that has been necessary to obtain a translation of a communication. The one-click translation system comprises a one-click translation component and a translation manager that combine to provide an almost seamless translation once a user clicks the one-click component. The one-click translation system does not address the quality of the translation.

Although the one-click system is a significant advance over the prior art, it still requires some action by the receiver of the communication. For translation of communications to be universally accepted, it must be completely seamless. A system is required that automatically delivers a communication in the preferred language of the recipient. The system must also deliver a better quality translation than is presently available.

Some recent technologies approach, but fail to achieve this ideal. For example, U.S. Pat. No. 6,161,082 assigned to AT&T Corp describes a network based language translation system that aims to improve machine translation by utilizing the processing power of a network to perform the translation rather than a local machine. However, this patent fails at clarifying how the detection of the involved languages is done. It only mentions that the source and target language can be detected from the communication between the two parties without indicating how this is achieved. The AT&T approach does not provide any intrinsic improvement in the quality of the translation, improvement is only achieved by increased processing power available in a networked environment.

U.S. Pat. No. 5,548,508, assigned to Fujitsu Limited, aims to improve the quality of a machine translation by embedding tags within a document that include contextual information. For example, a <TITLE>. . . </TITLE> tag indicates that the words are the title and should be displayed accordingly, a <MODIFY>. . . </MODIFY> tag may be used to define the correct order of translated words. The tags operate on small parts of a document rather than globally. To be effective the invention requires a translation program that supports Fujitsu's extended tag set. The Fujitsu invention achieves the aim of providing a machine translation with higher accuracy but does so at the cost of significant pre and post processing that slows the translation. Using the Fujitsu approach it is not possible to provide machine translations in a seamless manner.

Recently granted U.S. Pat. No. 6,073,143, assigned to Sanyo Electric Co. Ltd describes a process to enhance the translation of HTML documents by adding a translation command to each hyperlink in the document. The invention seeks to address the problem of lost hyperlinks that occur during translation. It does not address improved translation of the actual document.

U.S. Pat. No. 5,848,386, assigned to Ricoh Company, describes an automated translation system for using different translation resources, such as dictionaries and rule data bases for translating different parts of a document. Tags are embedded in the document to define the structure of the document to be translated, in order to select the dictionaries and/or rules which are to be used for the translation process. However, the system requires a “document type definition” to be created for each document to be translated. The translation only works for documents which have a predefined structure rather than documents such as web pages on the Internet.

### DISCLOSURE OF THE INVENTION

In one form, although it need not be the only or indeed the broadest form, the invention resides in a translation information segment associated with an electronic communication:

said translation information segment including global parameters for effecting a translation of said electronic communication or a part or parts thereof from a source language to one or more target languages; and

said translation information segment being identified and actioned by an application reading the electronic communication to extract the translation parameters to obtain the translation of the electronic communication from said source language to said one or more target languages.

The translation information segment may be embedded in the. electronic communication or attached to the electronic communication. Alternatively the translation information segment may be stored in an accessible database and a pointer or pointers are either embedded or attached to the translatable electronic communication.

The global parameters may be selected from parameters including, but not limited to: source language, encoding, tense, available translation, translation engine, dictionary, glossary, context, translation service, individual translator, rules for processing tags such as HTML tags, rules for processing components within the electronic communication such as pictures, graphics, sound, animation, video, software, programmable routines, rules for performing the translation, location of existing translations, location of existing localized components of said electronic communication such as pictures, graphics, sound, animation, video, software, programmable routines, and translation memory.

Preferably, the application actioning the translation information, includes a web browser for web pages, or an email program for email, or a word processor for text documents. Alternatively, a purpose specific application may detect and action the translation information segment.

There may be two or more translation information segments associated with an electronic communication. Each translation information segment includes parameters for translation of a portion of the electronic communication associated with the translation information segment.

In another form the invention resides in a translation information segment associated with an electronic communication, said translation information segment being identified and actioned by an application reading the electronic communication and comprising at least one of: a pointer to a translation of the electronic communication; a pointer to location of existing translations, a pointer to location of existing localized components of said electronic communication such as pictures, graphics, sound, animation, video, software, programmable routines; a pointer to rules for performing the translation; a pointer to rules for processing components within the electronic communication such as pictures, graphics, sound, animation, video, software, programmable routines; a pointer to a translation engine for translating the electronic communication; a pointer to dictionaries, glossaries, or terminology databases; or a pointer to a human translator skilled in translating the electronic communication.

The pointer to a translation of the electronic communication is suitably a universal resource locator and preferably a list of pointers point to different language translations.

The translation information segment preferably also includes a list of translation parameters or a pointer to a file containing a list of translation parameters. The translation parameters are suitably readable by a translation engine or a human translator to improve the quality of translation.

In a still further form the invention resides in a method of providing a translated communication to a recipient of a foreign language communication including the steps of:

associating a translation information segment with the foreign language communication;

transmitting the foreign language communication and translation information segment to a receiver;

parsing the foreign language communication to identify and analyze the translation information segment; and

obtaining a translation of the foreign language communication according to parameters in the translation information segment.

When a translation is requested from a browser, the translation information segment information may be extracted from the communication and forwarded to a translation manager along with a translation request.

Alternatively when a browser receives a communication to display, it may first check the translation information segment to ensure the language is correct before displaying, if not it may request a translation from a translation manager.

Another alternative is for a web server to obtain a users preferred language and compare it to the translation information segment, if it does not match, then the web server could request the communication to be translated and provide the relevant details from the translation information segment to the translation manager.

Yet another alternative is for the machine translation engine to view the translation information segment directly and use that information to perform a better translation.

It does not matter if the translation information segment information is used at either the client or the server end. The key is the information within the translation information segment is used to help the translation manager obtain the best translation.

In some cases, the translation manager could be bypassed. For example if the browser views the translation information segment when requesting a translation and sees a URL where the desired translation is available, the browser could simply request that translation from the said URL.

### BRIEF DESCRIPTION OF THE DRAWINGS

To assist in understanding the invention, preferred embodiments will be described with reference to the following figures in which:

FIG. 1 shows a flowchart of seamless translation process;

FIG. 2 shows a flowchart of a non-seamless translation process; and

FIG. 3 shows a system overview of a translation process utilizing a translation information segment.

### DETAILED DESCRIPTION OF THE DRAWINGS

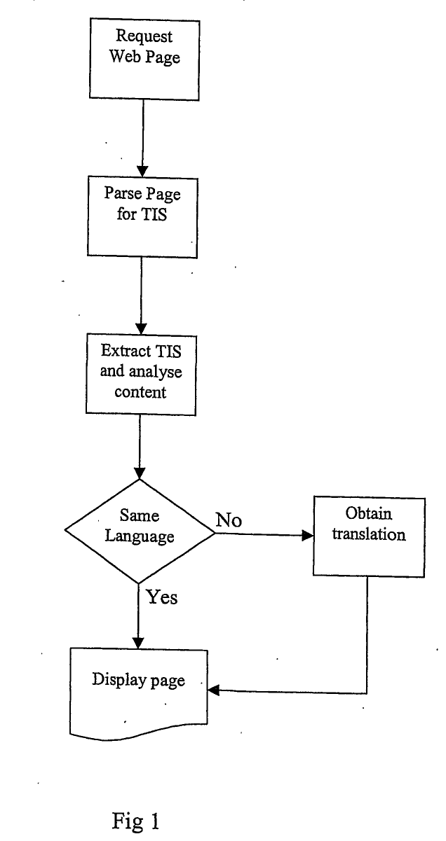

Referring to FIG. 1, there is shown a flowchart of a seamless method of translating a communication from a source language to a target language. For ease of description the method is described in respect of a single translation of a web page from a source language to a target language, it will be appreciated that it is trivial to extend the process to translate multiple communications to multiple languages. Furthermore, any electronic communication can be translated according to the method including text documents, email, SMS messages, and audio files, video, etc.

A key element of the method is the inclusion of a translation information segment (TIS) with the communication. The TIS provides information that can make the translation seamless to sender and recipient of the communication. In the simplest form, the TIS provides one piece of information to help obtain the best translation of the communication. The one piece of information could be any of the parameters described in this application such as a URL that already has a professionally translated version of the communication available, or a translation memory that already has many of the phrases and sentences translated.

The TIS is not just about obtaining a better machine translation, but is about trying to obtain the best translation. This means leveraging off an existing human translation where possible, so if a professionally human translated version is available, then it may be obtained. Or if human translated segments are available In a translation memory, they may be obtained.

In a more complex form (described in detail below) the TIS includes a fuller list of all parameters for obtaining a better translation of the communication to the target language, including such parameters as tone, subject matter, preferred dictionary, preferred glossary, preferred translation engine, words to exclude, data to ignore, translation service, location of existing translations, location of existing localized components such as pictures, graphics, sound, animation, video, software, rules for processing tags (eg HTML tags), rules for processing components of the communication such as graphics, guidelines, programmable routines, and payment method (for commercial translations). It will be realized that some of these parameters are useful to human translators as well as machine translators, for example a dictionary or glossary. The benefit of the TIS is not limited to machine translation.

The TIS may alternatively consist of a pointer or pointers to a file that contains some or all of the parameters listed above. This embodiment is essentially equivalent to having the information embedded with the communication but may be more efficient in a network environment where a translation manager maintains a database of translation parameters which are retrieved according to the TIS identifier at the time of translation.

A seamless translation system may also be provided for communications that do not include a TIS but this process is described in our co-pending application titled “Seamless Translation System”.

There may be a different TIS associated with different parts of a communication. For example, a communication may include a quoted section that has a different tone from the rest of the communication. To obtain a quality communication the TIS for the bulk of the document will have a different set of parameters from the TIS associated with the quoted section. For ease of explanation a single TIS is described associated with a single communication but the invention may be extended to multiple TIS with each communication.

In FIG. 1, the method commences when a user requests a web page. The users browser parses the web page for the TIS. An example generic TIS may have the following structure:

```
<?xml version=“1.0” encoding=“UTF-8”?>
<TIS>
  <Version>1.0</Version>
  <SourceLang>en</SourceLang>
  <MIME-Type>text/rtf</MIME-Type>
  <Encoding>ISO8859-1</Encoding>
  <Tense>
    <Item1>formal</Item1>
    <Item2>business</Item2>
  </Tense>
  <AvailableTranslation>
    <de_DE>http://www.source.com/reference</de_DE>
    <fr_CA>file://lanhost//d:/path/docname</fr_CA>
  </AvailableTranslation>
  <TranslationMemory>
    <Item1>TM-1 reference</Item1>
    <Item2>TM-2 reference</Item2>
  </TranslationMemory>
  <Service>
    <Engine>special engine xyz</Engine>
    <PreferredAgency>Worldlingo</PreferredAgency>
    <PreferredTranslator>
      <Item1>
        <Language>de</Language>
        <Name>Hans Schmidt</Name>
      </Item1>
      <Item2>
        <Language>it</Language>
        <Name>Bruno Zagani</Name>
      </Item2>
    </PreferredTranslator>
  </Service>
  <Dictionary>
    <Item1>Dictionary 1 reference</Item1>
    <Item2>Dictionary 2 reference</Item2>
  </Dictionary>
<Glossary>
  <Item1>Glossary 1 reference</Item1>
  </Glossary>
  <DNT>
  <Item1>Microsoft</Item1>
  <Item2>Worldlingo</Item2>
  </DNT>
  <DNT-List>
    <Item1>http://www.source.com/dnt-list-doc</Item1>
  </DNT-List>
  <Use>
    <Item1>marketing</Item1>
  </Use>
  <Industry>
    <Item1>engineering</Item1>
  </Industry>
  <Rulesets>
    <Tagged>
      <Tagged1>
        <Type>html</Type>
        <Item1>
          <Name>rules</Name>
          <Item1>
              <Expr>if (stillTranslate) then translateContent( )</Expr>
          </Item1>
        </Item1>
        <Item2>
          <Name>base</Name>
          <Item1>
              <Expr>if (hasAttribute(“href”)) then
              parse(attribute(“href”))</Expr>
          </Item1>
        </Item2>
      </Tagged1>
    </Tagged>
  </Rulesets>
</TIS>
```

The actual markers will vary in any given situation and may include a subset of those shown in the example or additional markers not shown.

The markers shown in the generic XML TIS have the following functions:

```
<TIS> ... </TIS>
    marks the start and end of the TIS;
<Version> ... </Version>
    indicates the version of the TIS structure;
<SourceLang> ... </SourceLang>
    marks the language of the communication;
<MIME-Type> ... </MIME-Type>
    indicates the MIME type;
<Encoding> ... </Encoding>
    indicates the encoding;
<Tense> ... </Tense>
    indicates the tense, this is read by the machine translation engine
    as a parameter that may improve the quality of the translation;
<Item#> ... </Item#>
    delimits multiple items for indicating priority. Item 1 applies before
    item 2;
<AvailableTranslation> ...</AvailableTranslation>
    lists available/preferred translations. For example, a web page may
    already have a foreign language equivalent that can be delivered
    instead of the accessed page;
<TranslationMemory> ... </TranslationMemory>
    points to a translation memory for retrieval of translations from a
    cache to avoid retranslation of translated documents or parts of
    documents;
<Service> ... </Service>
    indicates preferences for the translation such as a particular
    translation engine or particular human translators;
<Engine> ... </Engine>
    the preferred engine;
<PreferredAgency> ... </PreferredAgency>
    the preferred agency for performing required translations;
<PreferredTranslator> ... </PreferredTranslator>
    the preferred human translator, perhaps according to each
    language;
<Dictionary> ... </Dictionary>
    the translation dictionary or dictionaries to be used;
<Glossary> ... </Glossary>
    the translation glossary or glossaries to be used;
<DNT> ... </DNT>
    a list of words or phrases not to translate;
<DNT-List> ... </DNT-List>
    a pointer to a file containing a list of words or phrases not to
    translate;
<Use> ... </Use>
    a context marker used by the translation engine to improve the
    quality of translation;
<Industry> ... </Industry>
    another context marker for improving the quality of translation;
<Rulesets> ... </Rulesets>
    A list of rules or guidelines that can be applied during the
    translation process.
```

Once the TIS is identified the browser extracts the translation parameters and performs actions accordingly. The first action is to check the source language tag against the preferred language of the user. The preferred language of the user may be obtained from the operating system setup, a cookie, a preferences file residing on the recipients computer or other accessible location, or from an analysis performed by suitable software. If the preferred language matches the source language there is no translation necessary and the page is displayed. If there is not a match a translation is obtained.

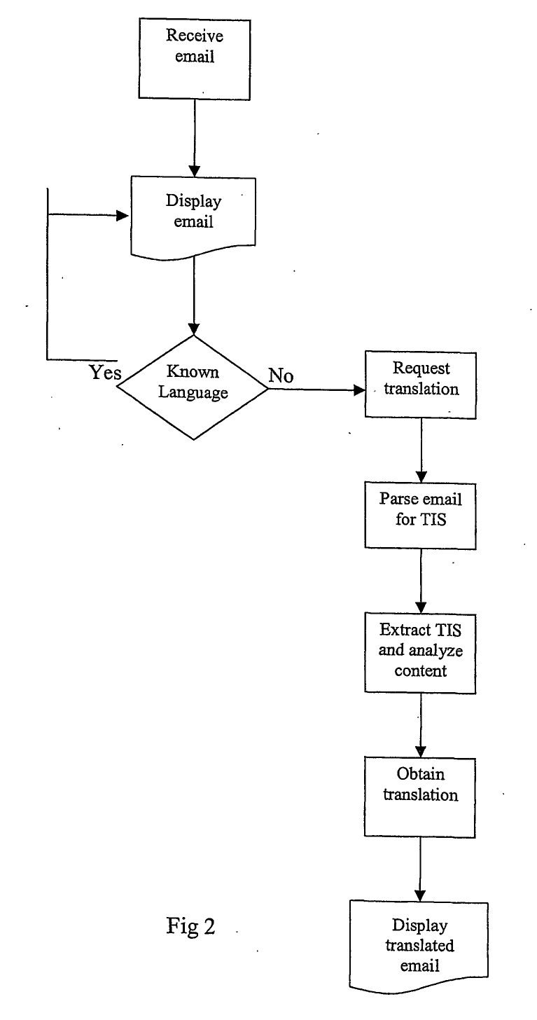

The TIS is not limited to facilitating a seamless translation of a communication. The TIS will also improve the quality of translation in a non-seamless system, such as the one-click translation system described in our co-pending application mentioned earlier. A non-seamless translation system utilizing the TIS is shown in FIG. 2.

The process depicted in FIG. 2 commences when a user receives, for example, an email and the email program displays the email. If the email is not in the preferred language of the recipient an action, such as clicking a one-click translation component, is taken to request a translation. A translation manager parses the email for a TIS. The content of the TIS is analyzed and a translation obtained according to the information contained in the TIS. For email this will normally mean supplying translation parameters to the translation engine.

An advantage of the TIS is that it may contain a redirection to a foreign equivalent of a requested communication. Many businesses maintain mirror sites in multiple languages. The TIS may contain pointers to these sites, as indicated in the previous generic sample.

In one example, this is implemented by using a rule to leverage off the location of the mirror page to remove the necessity for specifying the localized web page name for each url. For example, the TIS may contain a pointer to a directory on a server where all localized .html files (webpages) applicable to this communication are stored. The TIS may also contain a pointer to a rule or set of rules as to how .html files are to be processed when the piece of communication is being processed.

For example the rule may say replace X or X_* (where * is a wild card and could represent any extension) with X_japanese when the communication is being translated into Japanese.

So as the piece of communication is being processed and a web page called homepage.html is processed, the TIS points to a rule that replaces homepage.html with homepage_japanese.html if homepage_japanese.html is in the location specified. Similarily the TIS may provide a pointer to where the localized graphics are stored so that tree_homepage_japanese.gif may be obtained, if available, from the specified location and included in the translation in the place of tree_homepage.gif.

As mentioned above, the TIS is not limited to web pages. The TIS can be added to email in a similar manner to the known use of VCARDs. The following example shows the attachment of a TIS to an email using a custom MIME-type (also called Content-Type) such as “text/x-tis”.

```
Content-Type: text/x-tis; name=“settings.tis”
Content-Transfer-Encoding: quoted-printable
Content-Disposition: attachment; filename=“settings.tis”
    <TIS>
    ...
    </TIS>
```

A TIS, such as shown in the earlier example, is embedded into a separate part of an email. These separate parts inside emails are common practice and represent attachments to the given email content. An advantage of the TIS as an attachment is that it is unaffected by transmission across the internet and is not dependent upon the mail handling system of individual mail servers.

An alternative embodiment for implementing the TIS in email is to add a custom header of the following form:

```
Received: from Laptop (isp.net [192.168.41.217]) by wlm.worldlingo.com
with SMTP (Microsoft Exchange Internet Mail Service Version #)
  id 1BV3QHTA; Fri, 9 Feb 2001 09:29:49 +1000
From: “###” <#@worldlingo.com>
To: “###” <#@worldlingo.com>
Subject: Patent
Date: Thu, ## ### ##
Message-ID: <######.#@worldlingo.com>
MIME-Version: 1.0
Content-Type: text/plain;
  charset=“iso-8859-1”
Content-Transfer-Encoding: 7bit
X-Priority: 1 (Highest)
X-MSMail-Priority: High
X-Mailer: Microsoft Outlook IMO, Build 9.0.2416 (9.0.2911.0)
X-MimeOLE: Produced By Microsoft MimeOLE V5.50.4133.2400
X-TIS-Version: 1.0
X-TIS-SourceLang: en
X-TIS-Service: Engine=engine1
X-TIS-Tense: formal, business
Importance: High
```

This example shows only a few fields of the possible TIS fields noted earlier in the generic XML structure example. Only required fields need to be included in the TIS for any particular application. Fields that are not required may be replaced with well-known and reasonable default values, or simply omitted.

The header embodiment of the TIS may also be applied to documents in text, RTF, or proprietary formats. Most documents contain header information that dictates the appearance of the document. The TIS can be added to this header information so that the document is seamlessly translated before being viewed by the receiver. The TIS could also be added to the properties dialog box of a document created using MSWord® or other proprietary word processors.

The TIS can also be included as part of HTML documents as shown in the following example of an HTML comment block.

```
<html xmlns:t=“urn:schemas-worldlingo-com:tis:tis”
xmlns=“http://www.w3.org/TR/REC-html40”>
<head>
<meta name=“X-TIS-Version” content=“1.0”>
<title>Reference Document</title>
<!--><xml>
  <t:TIS>
  <t:SourceLang>en</t:SourceLang>
  <t:Version>1.0</t:Version>
  <t:MIME-Type>text/rtf</t:MIME-Type>
  <t:Encoding>ISO8859-1</t:Encoding>
  <t:Tense>
    <t:Item1>formal</t:Item1>
    <t:Item2>business</t:Item2>
  </t:Tense>
  <t:Industry>
    <t:Item1>engineering</t:Item1>
  </t:Industry>
  </t:TIS>
</xml><!-->
```

An alternative solution for using the TIS with HTML documents as shown in the following example of an HTML meta tag.

<HTML>
<HEAD>
<META name=“X-TIS-Version” content=“1.0”>
<META name=“X-TIS-SourceLang” content=“en”>
<META name=“X-TIS-Service” content=“Engine|engine1”>
<META name=“X-TIS-Tense” content=“formal,business”>
<TITLE>Search Results</TITLE>
</HEAD>
<BODY>
...
</BODY>

The TIS is not limited to text applications. Rudimentary translation engines are available for translating voice to text, text to voice, and voice to voice. The TIS can dramatically improve the usefulness of these rudimentary translation engines by defining parameters such as tone, accent, content and field.

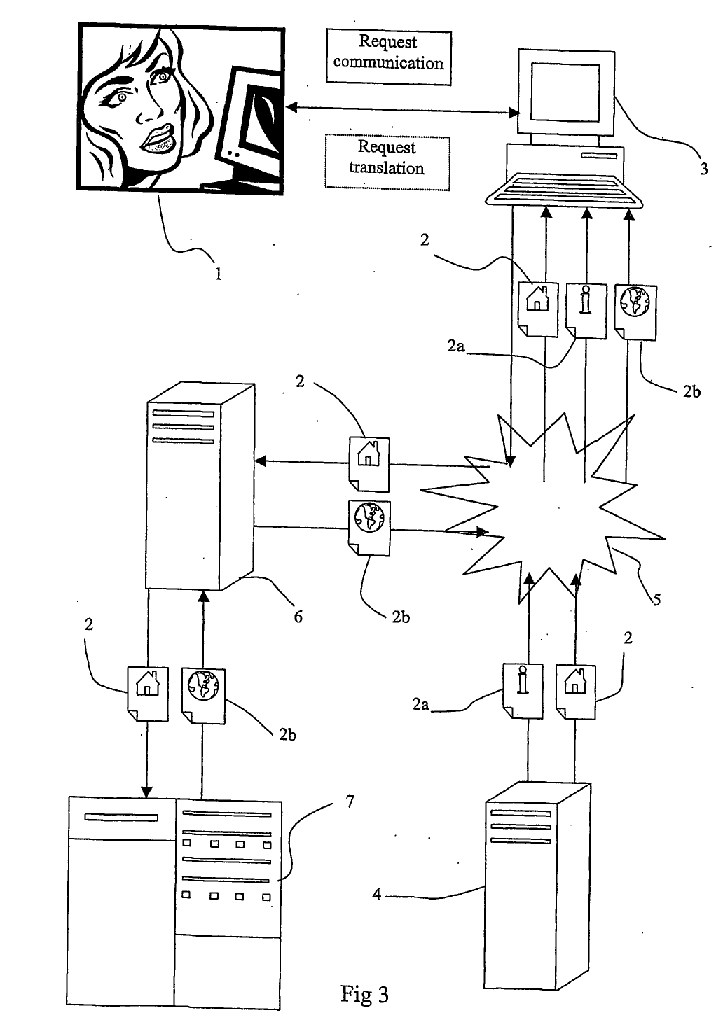

A schematic of a practical implementation of the TIS in a network environment is shown in FIG. 3. A user 1 requests or receives a communication, such as a web page 2, using a browser on a personal computer 3. The browser requests the page 2 from a web server 4 via the internet 5, and it is displayed on the personal computer 3.

If the communication is in a language foreign to the user, the user 1 may request a translation. As discussed above, this step may occur automatically according to the process described in our co-pending application. The browser on the personal computer parses the communication for a TIS and requests a translation via the internet 5 using the parameters obtained from the TIS.

If the web server 4 has a suitable translation 2a of the communication 2 it is supplied directly to the user 1. If a suitable translation is not available the translation request is passed to a translation manager 6 with the parameters from the TIS. The translation manager 6 obtains the translation 2b from a translation engine 7.

For ease of explanation the translation manager 6 and translation engine 7 have been shown separately. These functions may be embodied in a single application or separate applications running on a single computer. The translation functions may even be performed locally on the personal computer 3 if appropriate software is installed.

The TIS may be read by the application receiving the communication but is not limited to this implementation. If a translation engine is resident on the receiver's computer, or in a network to which the receiver is connected, the translation engine may directly interpret the TIS. More suitably, a server in the network may be configured as a translation manager that detects a TIS and manages the translation of the communication before delivering the communication to the recipient. The translation manager may be resident on the computer of the recipient.

The application of the TIS to specific cases will now be explained to assist with understanding the invention.

Most existing on-line businesses have originated in the west and have developed their web pages and documents in English. However, the fastest growing Internet access is occurring in areas where English is not the first language and may not even be spoken by many people who may be potential customers. In order to market to these potential customers a web page and documents must be presented in their native language. Most people will not go to the trouble of translating a page and certainly will not pay for the translation. In order to market to these people the translation must occur seamlessly.

The translation may occur in a number of ways, all of which are facilitated by the TIS. Firstly, the recipient may have machine translation software resident on their computer. In this case the TIS provides all relevant parameters to seamlessly result in display of a high quality translation. Secondly, the recipient will be attached to the Internet so the TIS can direct the web page to a translation manager that makes the necessary translation and displays it seamlessly to the recipient. Thirdly, the originator may have already produced a mirror site in the relevant language, in which case the TIS seamlessly directs the browser of the recipient to the mirror site.

To achieve maximum effectiveness the parameters contained in the TIS must be relevant and understandable by the translation engine being employed. As there is a wide range of translation engines this requirement could present difficulty. However, the inventor has realized that the TIS contains an extendible generic set of parameters. It is a relatively straightforward problem for a machine translation engine to interpret the TIS and convert the generic parameters into specific commands. The inventor envisages that it would also be possible to generate conversion programs to interpret the generic TIS parameters for legacy translation engines.

An important advantage of the present invention is the flexibility it allows a user to customize the way the translation is performed for a particular piece of communication. Rather then a generic, broad approach, the TIS provides pointers to specific information, rules, guidelines, and resources that allow the user to obtain a better translation.

This flexibility to customize, while not limited to, is particularly important on the internet where documents and pieces of communication are not necessarily read from top to bottom, but are navigated through. Furthermore, the method by which that navigation takes place can be designed/defined by each individual webmaster—for example by the custom JavaScript they write. So a generic, approach cannot cover all instances. The flexibility to customize is therefore essential for the translation to be performed properly as the user navigates through the document or piece of communication.

In a further embodiment, two (2) or more of the TIS parameters may leverage off each other to provide a better translation. For example, the TIS may contain a pointer to a directory on a server where all localized graphics applicable to this piece of communication are stored. The TIS may also contain another pointer to a rule or set of rules as to how graphics are to be processed when the piece of communication is being processed.

Referring to the example described earlier a rule may state, replace X or X_* (where * is a wild card and could represent any extension) with X_japanese when the communication is being translated into Japanese. Hence, as the piece of communication is being process and a graphic called tree.gif is processed, the TIS points to a rule that says to replace tree.gif with tree_japanese.gif and the TIS provides a pointer to where the localized graphics are stored so that tree_japanese.gif may be obtained and included in the translation if there is a tree_japanese.gif at that storage location.

The advantage of the TIS of the present invention is the ability for one TIS parameter to leverage off another, which simplifies the implementation, management, and maintenance of the translation system and resources it uses to perform the translations. It allows the user to define naming conventions for localized components like graphics. For example add a “_Language” to the graphic name for each target language where in the above example “_Language” is “_Japanese. One generalized rule can be written as explained above, rather then writing a specific rule for each individual graphic.

The leveraging of one TIS parameter by another can be applied to a wide range of components within the document and/or different file types.

The internet has taken the decision about what to translate out of an organizations hands. If a user wants a translation, they can easily obtain one through a variety of cheap or free online translation sites. A challenge to organizations is to make sure the translation obtained from these online translation sites portray the organization and/or its products and services in a favorable light. The TIS provides a conduit for an organization to expose its translation assets and resources for the purpose of allowing a user to obtain a more accurate translation that is more likely to portray the message sought by the organization.

Throughout the specification the aim has been to describe embodiments of the invention without limiting the invention to any specific combination of alternate features.

1-17. (canceled)

18. A translation information segment associated with an electronic communication: said translation information segment including global parameters for effecting a translation of said electronic communication or a part or parts thereof from a source language to one or more target languages; and
said translation information segment being identified and actioned by an application reading the electronic communication to extract the translation parameters to obtain the translation of the electronic communication from said source language to said one or more target languages.

19. A translation information segment according to claim 18 wherein the translation information segment is embedded in the electronic communication or attached to the electronic communication.

20. A translation information segment according to claim 18 wherein the translation information segment is stored in an accessible database and a pointer or pointers are either embedded or attached to the translatable electronic communication.

21. A translation information segment according to claim 18, wherein the global parameters are selected from parameters including: source language, encoding, tense, available translation, translation engine, dictionary, glossary, context, translation service, rules for processing tags, rules for processing components within the electronic communication such as pictures, graphics, sound, animation video, software, programmable routines, rules for performing translation, location of existing translations, location of existing localized components of said electronic communication such as pictures, graphics, sound, animation, video, software, programmable routines; individual translator, and translation memory.

22. A translation information segment according to claim 19, wherein the global parameters are selected from parameters including: source language, encoding, tense, available translation, translation engine, dictionary, glossary, context, translation service, rules for processing tags, rules for processing components within the electronic communication such as pictures, graphics, sound, animation video, software, programmable routines, rules for performing translation, location of existing translations, location of existing localized components of said electronic communication such as pictures, graphics, sound, animation, video, software, programmable routines; individual translator, and translation memory.

23. A translation information segment according to claim 20, wherein the global parameters are selected from parameters including: source language, encoding, tense, available translation, translation engine, dictionary, glossary, context, translation service, rules for processing tags, rules for processing components within the electronic communication such as pictures, graphics, sound, animation video, software, programmable routines, rules for performing translation, location of existing translations, location of existing localized components of said electronic communication such as pictures, graphics, sound, animation, video, software, programmable routines; individual translator, and translation memory.

24. A translation information segment according to claim 18 wherein two or more parameters of the TIS act cooperatively to translate a part or parts of said electronic communication.

25. A translation information segment according to claim 19 wherein two or more parameters of the TIS act cooperatively to translate a part or parts of said electronic communication.

26. A translation information segment according to claim 20 wherein two or more parameters of the TIS act cooperatively to translate a part or parts of said electronic communication;

27. A translation information segment according to claim 21 wherein two or more parameters of the TIS act cooperatively to translate a part or parts of said electronic communication.

28. A translation information segment according to claim 22 wherein two or more parameters of the TIS act cooperatively to translate a part or parts of said electronic communication.

29. A translation information segment according to claim 23 wherein two or more parameters of the TIS act cooperatively to translate a part or parts of said electronic communication.

30. A translation information segment according to claim 18 wherein the application actioning the translation information segment includes a web browser for web pages, or an email program for email, or a word processor for text documents.

31. A translation information segment according to claim 19 wherein the application actioning the translation information segment includes a web browser for web pages, or an email program for email, or a word processor for text documents.

32. A translation information segment according to claim 20 wherein the application actioning the translation information segment includes a web browser for web pages, or an email program for email, or a word processor for text documents.

33. A translation information segment according to claim 21 wherein the application actioning the translation information segment includes a web browser for web pages, or an email program for email, or a word processor for text documents.

34. A translation information segment according to claim 22 wherein the application actioning the translation information segment includes a web browser for web pages, or an email program for email, or a word processor for text documents.

35. A translation information segment according to claim 23 wherein the application actioning the translation information segment includes a web browser for web pages, or an email program for email, or a word processor for text documents.

36. A translation information segment according to claim 24 wherein the application actioning the translation information segment includes a web browser for web pages, or an email program for email, or a word processor for text documents.

37. A translation information segment according to claim 25 wherein the application actioning the translation information segment includes a web browser for web pages, or an email program for email, or a word processor for text documents.

38. A translation information segment according to claim 26 wherein the application actioning the translation information segment includes a web browser for web pages, or an email program for email, or a word processor for text documents.

39. A translation information segment according to claim 27 wherein the application actioning the translation information segment includes a web browser for web pages, or an email program for email, or a word processor for text documents.

40. A translation information segment according to claim 28 wherein the application actioning the translation information segment includes a web browser for web pages, or an email program for email, or a word processor for text documents.

41. A translation information segment according to claim 29 wherein the application actioning the translation information segment includes a web browser for web pages, or an email program for email, or a word processor for text documents.

42. A translation information segment according to claim 18 wherein the application actioning the translation information segment is a purpose specific application that detects and actions the translation information segment.

43. A translation information segment according to claim 19 wherein the application actioning the translation information segment is a purpose specific application that detects and actions the translation information segment.

44. A translation information segment according to claim 20 wherein the application actioning the translation information segment is a purpose specific application that detects and actions the translation information segment.

45. A translation information segment according to claim 21 wherein the application actioning the translation information segment is a purpose specific application that detects and actions the translation information segment.

46. A translation information segment according to claim 22 wherein the application actioning the translation information segment is a purpose specific application that detects and actions the translation information segment.

47. A translation information segment according to claim 23 wherein the application actioning the translation information segment is a purpose specific application that detects and actions the translation information segment.

48. A translation information segment according to any one of claim 24 wherein the application actioning the translation information segment is a purpose specific application that detects and actions the translation information segment.

49. A translation information segment according to claim 25 wherein the application actioning the translation information segment is a purpose specific application that detects and actions the translation information segment.

50. A translation information segment according to claim 26 wherein the application actioning the translation information segment is a purpose specific application that detects and actions the translation information segment.

51. A translation information segment according to claim 27 wherein the application actioning the translation information segment is a purpose specific application that detects and actions the translation information segment.

52. A translation information segment according to claim 28 wherein the application actioning the translation information segment is a purpose specific application that detects and actions the translation information segment.

53. A translation information segment according to claim 29 wherein the application actioning the translation information segment is a purpose specific application that detects and actions the translation information segment.

54. A translation information segment according to claim 18 wherein there are two or more translation information segments associated with said electronic communication.

55. A translation information segment according to claim 19 wherein there are two or more translation information segments associated with said electronic communication.

56. A translation information segment according to claim 20 wherein there are two or more translation information segments associated with said electronic communication.

57. A translation information segment according to claim 21 wherein there are two or more translation information segments associated with said electronic communication.

58. A translation information segment according to claim 22 wherein there are two or more translation information segments associated with said electronic communication.

59. A translation information segment according to claim 23 wherein there are two or more translation information segments associated with said electronic communication.

60. A translation information segment according to claim 24 wherein there are two or more translation information segments associated with said electronic communication.

61. A translation information segment according to claim 25 wherein there are two or more translation information segments associated with said electronic communication.

62. A translation information segment according to claim 26 wherein there are two or more translation information segments associated with said electronic communication.

63. A translation information segment according to claim 27 wherein there are two or more translation information segments associated with said electronic communication.

64. A translation information segment according to claim 28 wherein there are two or more translation information segments associated with said electronic communication.

65. A translation information segment according to claim 29 wherein there are two or more translation information segments associated with said electronic communication.

66. A translation information segment according to claim 30 wherein there are two or more translation information segments associated with said electronic communication.

67. A translation information segment according to claim 31 wherein there are two or more translation information segments associated with said electronic communication.

68. A translation information segment according to claim 32 wherein there are two or more translation information segments associated with said electronic communication.

69. A translation information segment according to claim 33 wherein there are two or more translation information segments associated with said electronic communication.

70. A translation information segment according to claim 34 wherein there are two or more translation information segments associated with said electronic communication.

71. A translation information segment according to claim 35 wherein there are two or more translation information segments associated with said electronic communication.

72. A translation information segment according to claim 36 wherein there are two or more translation information segments associated with said electronic communication.

73. A translation information segment according to claim 37 wherein there are two or more translation information segments associated with said electronic communication.

74. A translation information segment according to claim 38 wherein there are two or more translation information segments associated with said electronic communication.

75. A translation information segment according to claim 39 wherein there are two or more translation information segments associated with said electronic communication.

76. A translation information segment according to claim 40 wherein there are two or more translation information segments associated with said electronic communication.

77. A translation information segment according to claim 41 wherein there are two or more translation information segments associated with said electronic communication.

78. A translation information segment according to claim 42 wherein there are two or more translation information segments associated with said electronic communication.

79. A translation information segment according to claim 43 wherein there are two or more translation information segments associated with said electronic communication.

80. A translation information segment according to claim 44 wherein there are two or more translation information segments associated with said electronic communication.

81. A translation information segment according to claim 45 wherein there are two or more translation information segments associated with said electronic communication.

82. A translation information segment according to claim 46 wherein there are two or more translation information segments associated with said electronic communication.

83. A translation information segment according to claim 47 wherein there are two or more translation information segments associated with said electronic communication.

84. A translation information segment according to claim 48 wherein there are two or more translation information segments associated with said electronic communication.

85. A translation information segment according to claim 49 wherein there are two or more translation information segments associated with said electronic communication.

86. A translation information segment according to claim 50 wherein there are two or more translation information segments associated with said electronic communication.

87. A translation information segment according to claim 51 wherein there are two or more translation information segments associated with said electronic communication.

88. A translation information segment according to claim 52 wherein there are two or more translation information segments associated with said electronic communication.

89. A translation information segment according to claim 53 wherein there are two or more translation information segments associated with said electronic communication.

90. A translation information segment according to claim 54 wherein each translation information segment includes parameters for translation of a portion of the electronic communication associated with the translation information segment.

91. A translation information segment according to claim 55 wherein each translation information segment includes parameters for translation of a portion of the electronic communication associated with the translation information segment.

92. A translation information segment according to claim 56 wherein each translation information segment includes parameters for translation of a portion of the electronic communication associated with the translation information segment.

93. A translation information segment according to claim 57 wherein each translation information segment includes parameters for translation of a portion of the electronic communication associated with the translation information segment.

94. A translation information segment according to claim 58 wherein each translation information segment includes parameters for translation of a portion of the electronic communication associated with the translation information segment.

95. A translation information segment according to claim 59 wherein each translation information segment includes parameters for translation of a portion of the electronic communication associated with the translation information segment.

96. A translation information segment according to claim 60 wherein each translation information segment includes parameters for translation of a portion of the electronic communication associated with the translation information segment.

97. A translation information segment according to claim 61 wherein each translation information segment includes parameters for translation of a portion of the electronic communication associated with the translation information segment.

98. A translation information segment according to claim 62 wherein each translation information segment includes parameters for translation of a portion of the electronic communication associated with the translation information segment.

99. A translation information segment according to claim 63 wherein each translation information segment includes parameters for translation of a portion of the electronic communication associated with the translation information segment.

100. A translation information segment according to claim 64 wherein each translation information segment includes parameters for translation of a portion of the electronic communication associated with the translation information segment.

101. A translation information segment according to claim 65 wherein each translation information segment includes parameters for translation of a portion of the electronic communication associated with the translation information segment.

102. A translation information segment according to claim 66 wherein each translation information segment includes parameters for translation of a portion of the electronic communication associated with the translation information segment.

103. A translation information segment according to claim 67 wherein each translation information segment includes parameters for translation of a portion of the electronic communication associated with the translation information segment.

104. A translation information segment according to claim 68 wherein each translation information segment includes parameters for translation of a portion of the electronic communication associated with the translation information segment.

105. A translation information segment according to claim 69 wherein each translation information segment includes parameters for translation of a portion of the electronic communication associated with the translation information segment.

106. A translation information segment according to claim 70 wherein each translation information segment includes parameters for translation of a portion of the electronic communication associated with the translation information segment.

107. A translation information segment according to claim 71 wherein each translation information segment includes parameters for translation of a portion of the electronic communication associated with the translation information segment.

108. A translation information segment according to claim 72 wherein each translation information segment includes parameters for translation of a portion of the electronic communication associated with the translation information segment.

109. A translation information segment according to claim 73 wherein each translation information segment includes parameters for translation of a portion of the electronic communication associated with the translation information segment.

110. A translation information segment according to claim 74 wherein each translation information segment includes parameters for translation of a portion of the electronic communication associated with the translation information segment.

111. A translation information segment according to claim 75 wherein each translation information segment includes parameters for translation of a portion of the electronic communication associated with the translation information segment.

112. A translation information segment according to claim 76 wherein each translation information segment includes parameters for translation of a portion of the electronic communication associated with the translation information segment.

113. A translation information segment according to claim 77 wherein each translation information segment includes parameters for translation of a portion of the electronic communication associated with the translation information segment.

114. A translation information segment according to claim 78 wherein each translation information segment includes parameters for translation of a portion of the electronic communication associated with the translation information segment.

115. A translation information segment according to claim 79 wherein each translation information segment includes parameters for translation of a portion of the electronic communication associated with the translation information segment.

116. A translation information segment according to claim 80 wherein each translation information segment includes parameters for translation of a portion of the electronic communication associated with the translation information segment.

117. A translation information segment according to claim 81 wherein each translation information segment includes parameters for translation of a portion of the electronic communication associated with the translation information segment.

118. A translation information segment according to claim 82 wherein each translation information segment includes parameters for translation of a portion of the electronic communication associated with the translation information segment.

119. A translation information segment according to claim 83 wherein each translation information segment includes parameters for translation of a portion of the electronic communication associated with the translation information segment.

120. A translation information segment according to claim 84 wherein each translation information segment includes parameters for translation of a portion of the electronic communication associated with the translation information segment.

121. A translation information segment according to claim 85 wherein each translation information segment includes parameters for translation of a portion of the electronic communication associated with the translation information segment.

122. A translation information segment according to claim 86 wherein each translation information segment includes parameters for translation of a portion of the electronic communication associated with the translation information segment.

123. A translation information segment according to claim 87 wherein each translation information segment includes parameters for translation of a portion of the electronic communication associated with the translation information segment.

124. A translation information segment according to claim 88 wherein each translation information segment includes parameters for translation of a portion of the electronic communication associated with the translation information segment.

125. A translation information segment according to claim 89 wherein each translation information segment includes parameters for translation of a portion of the electronic communication associated with the translation information segment.

126. A translation information segment associated with an electronic communication, said translation information segment being identified and actioned by an application reading the electronic communication and comprising at least one of: a pointer to a translation of the electronic communication; a pointer to location of existing translations, a pointer to location of existing localized components of said electronic communication such as pictures, graphics, sound, animation, video, software, programmable routines; a pointer to rules for performing the translation; a pointer to rules for processing components within the electronic communication such as pictures, graphics, sound, animation, video, software, programmable routines; a pointer to a translation engine for translating the electronic communication; a pointer to dictionaries, glossaries, or terminology databases; or a pointer to a human translator skilled in translating the electronic communication.

127. A translation information segment according to claim 126 wherein the pointer to a translation of the electronic communication is a universal resource locator and a list of pointers point to different language translations.

128. A translation information segment according to claim 126 wherein the translation information segment includes a list of translation parameters or a pointer to a file containing a list of translation parameters.

129. A translation information segment according to claim 128 wherein the translation parameters are readable by a translation engine or a human translator to improve the quality of translation.

130. A method of providing a translated communication to a recipient of a foreign language communication including the steps of:
associating a translation information segment with the foreign language communication; transmitting the foreign language communication and translation information segment to a receiver;
parsing the foreign language communication to identify and analyze the translation information segment; and
obtaining a translation of the foreign language communication according to parameters in the translation information segment.

131. A method of providing a translated communication to a recipient of a foreign language communication according to claim 130 wherein, a translation is requested from a browser, and the translation information segment information is extracted from the communication and forwarded to a translation manager along with a translation request.

132. A method of providing a translated communication to a recipient of a foreign language communication according to claim 130 wherein,
when a browser receives a communication to display, it first checks the translation information segment to ensure the language is correct before displaying, and
if said language is not correct then the browser requests a translation from a translation manager.

133. A method of providing a translated communication to a recipient of a foreign language communication according to claim 130 wherein,
a web server obtains a users preferred language and compares it to the translation information segment, and if it does not match, then,
the web server requests the communication to be translated and provides the relevant details from the translation information segment to the translation manager.
